(19) United States
(12) Patent Application Publication
(10) Pub. No.: US 2005/0040552 A1
(43) Pub. Date: Feb. 24, 2005

(54) Method and apparatus for compression molding of a graphite plate

(76) Inventor: George J. Gemberling, Sleepy Hollow, IL (US)

Correspondence Address: Douglas B. White, 1901 N Roselle Road, Suite 802, Schaumburg, IL, 60195, US

(21) Appl. No.: 10/646,232

(22) Filed: Aug. 22, 2003

(51) Int. Cl. B29C 35/00

(52) U.S. Cl. 264/40.1; 264/109; 264/325; 425/447; 425/406

(57) ABSTRACT

A moveable table has a target area defined thereon. A hopper filled with an accurate amount of the moldable graphite mixture sifts and meters this mixture through screens onto the target area. The moveable table then shifts to place the target area over the mold cavity, whereupon a door is opened to allow the graphite material to drop evenly into the mold cavity. The compression mold includes a moveable ring surrounding the mold cavity which defines a well for receipt of the graphite material. After compression molding, the mold is opened and the ring is lowered to expose the finished part for removal.

### CROSS REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates generally to the field of compression molding of items utilizing thermosetting resins. More specifically, this invention relates to the field of molding graphite plates for the fuel cell industry using a powdery mixture of graphite and resin.

2. Description of the Prior Art

Fuel cells employing graphite plates for the electrochemical production of electricity from hydrogen are well known and have been constructed by a variety of prior art methods in an attempt to produce effective and economical devices.

Compression molding of products using thermosetting resins that harden under heat and pressure is also well known, but compression molding of the powdery mixture of graphite and thermosetting resin for graphite plates has presented a number of difficulties that remain unresolved by the prior art. See for example the following references:

| Patent Number | Inventor |
|---|---|
| U.S. Pat. No. 6,451,471 | Braun |
| U.S. Pat. No. 6,494,926 | Saito et al. |
| U.S. Pat. No. 6,436,568 | Schilling et al. |
| U.S. Pat. No. 6,180,275 | Braun et al. |
| U.S. Pat. No. 4,737,421 | Uemura et al. |
| U.S. Pat. No. 4,076,899 | Kring |

None of these references describe any means for assuring the accurate and even distribution of the powdery molding material loaded into the mold or any means for releasing the fragile molded plate from the mold.

Typical compression molding materials are putty-like in consistency. As a result, they are easy to measure, preform and insert into a mold. Moreover, typical molding materials spread out evenly in the mold during compression, equalizing the density of the molded part, and then shrink after molding to automatically release the molded part from the sides of the mold.

In contrast, the graphite/resin mixture used for production of graphite plates is light and powdery in its pre-molded state and must be accurately measured and evenly spread in the mold cavity before being compressed and molded, as any inaccuracy or unevenness results in an unacceptable finished product. Finally, unlike typical compression molding materials, this graphite/resin mixture expands during molding, causing the finished part to fit tightly and bind within the mold. And since the molded graphite plate is thin and brittle, ejection of such a tight fitting part by typical ejection techniques is impractical.

### SUMMARY OF THE INVENTION

The principal object of the present invention is to provide an apparatus and method for facilitating the compression molding of graphite parts, such as graphite fuel cell electrode plates, which are molded from a graphite/resin mixture.

More particularly, it is an object of this invention to provide an apparatus and method for achieving an accurate and even distribution of this powdery molding material in the mold.

It is a further object of this invention to mold this material in a compression mold designed to facilitate the deposition of the molding material and the removal of the fragile finished molded part.

The above objects, as well as other objects, are accomplished by a mold loading apparatus and method that evenly distributes the graphite/resin mixture onto a target area and then delivers this material to an improved compression mold.

The mold loading apparatus includes a moveable table having a target area defined thereon. A hopper mounted on the table, filled with an accurate amount of the graphite mixture, sifts this mixture through screens onto the target area while reciprocating across the target area. When the target area is evenly covered with the graphite mixture, the moveable table shifts to place the target area over the mold cavity, whereupon a door is opened to allow the graphite material to drop evenly into the mold cavity.

The improved compression mold includes a mold core, a mold cavity, and a moveable ring surrounding the mold cavity. The graphite/resin mixture dropped from the target area of the moveable table is received into a well defined by the ring and the mold cavity. The mold core is then forced against the mixture in the mold cavity and heat is applied to harden the resin. After the molded part has hardened, the mold is opened and the ring is lowered to expose the finished part.

### BRIEF DESCRIPTION OF THE DRAWINGS

FIG. 1 is a perspective view of the mold loading portion of the apparatus and method of the present invention.

FIG. 2 is an enlarged view of a portion of the apparatus of FIG. 1 showing the hopper and target area of the invention.

FIG. 3 is an elevation view of the gear mechanism which drives blades within the hopper.

FIG. 4 is a sectional view of the hopper showing the screens and rotating blades.

FIG. 5A depicts the mold cavity of the present invention having the target area of the moveable table positioned to load the mold cavity well of the compression mold.

FIG. 5B depicts the opening of the door under the target area to deposit the moldable material into the mold cavity.

FIG. 5C depicts the compression molding operation by the application of pressure of the mold core against the mold cavity.

FIG. 5D depicts the opened mold, the lowered mold cavity ring, and the removal of the molded part.

While the invention will be described in connection with a preferred embodiment, it will be understood that it is not the intent to limit the invention to that embodiment. On the contrary, it is the intent to cover all alternatives, modifications, and equivalents as may be included within the spirit and scope of the invention as defined by the appended claims.

### DESCRIPTION OF THE PREFERRED EMBODIMENT

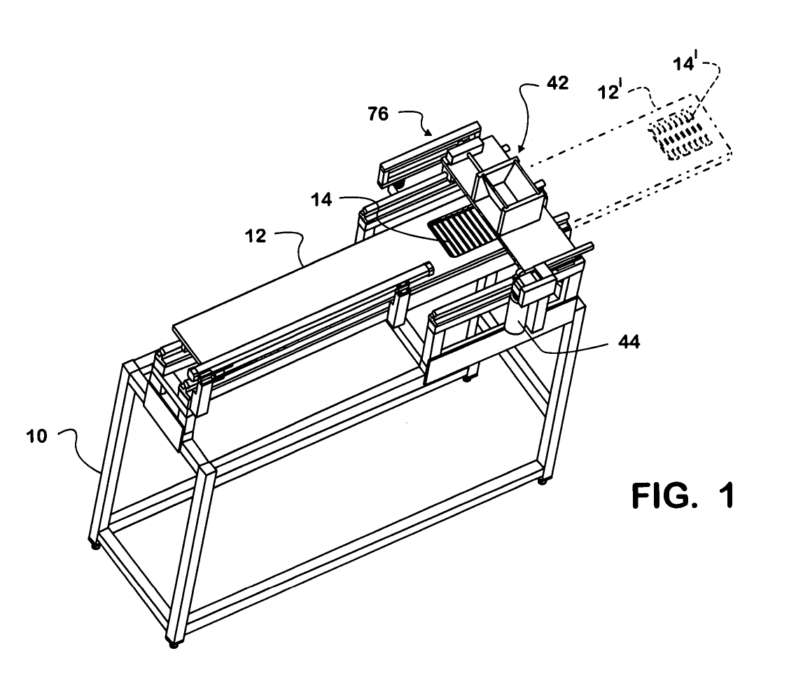

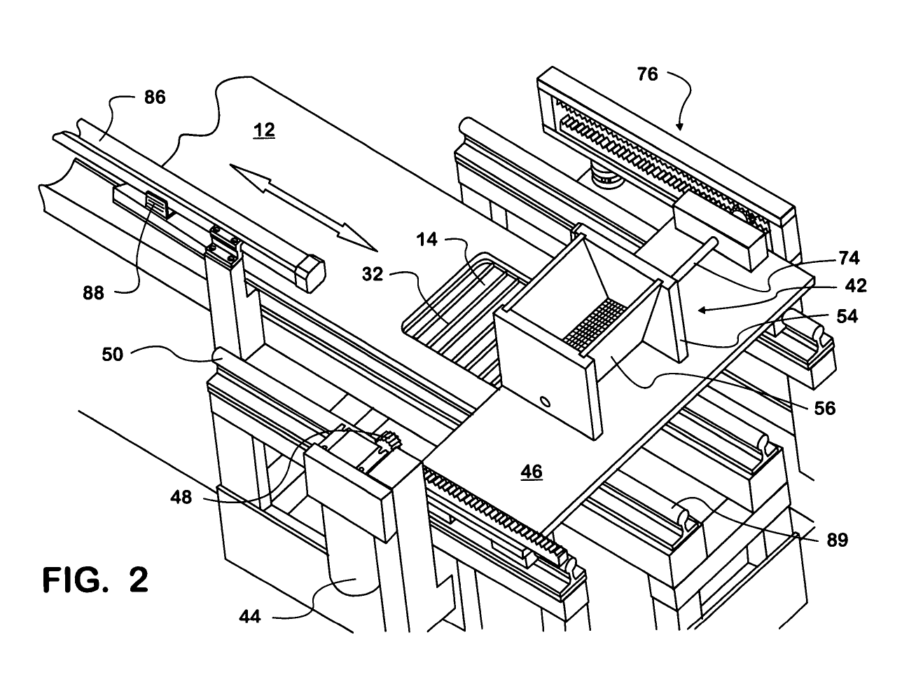

Turning first to FIGS. 1 and 2 there is shown a perspective view of the compression mold loading portion of the apparatus in accordance with the present invention. Generally this apparatus includes a base 10 and a moveable table 12. The moveable table is arranged to move between a first position for filling the target area with particulate moldable material and a second position (shown in phantom in FIG. 1) for depositing the particulate moldable material into the mold. This apparatus deposits a measured amount of the powdery particulate molding material (such as a graphite/resin mixture) evenly onto a target area 14 and then carries it to the mold cavity of the compression mold, as is described below in greater detail.

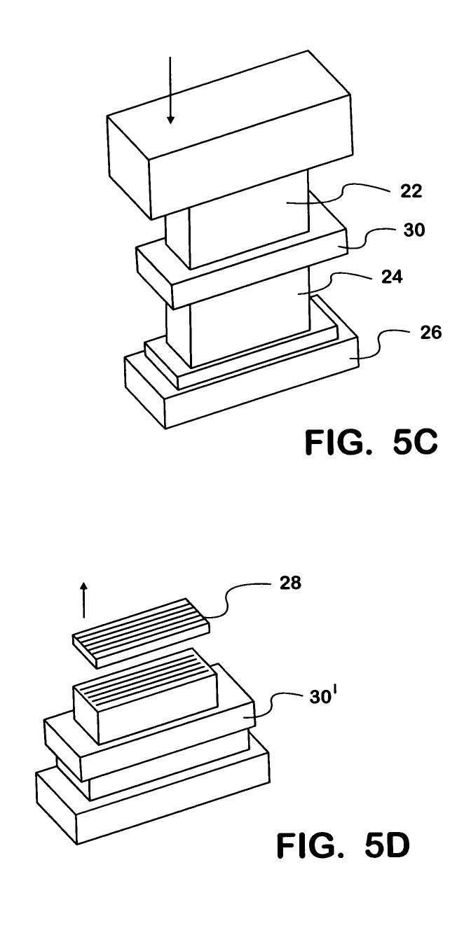

The compression mold (FIG. 5C) comprises an upper mold core member 22 and a lower mold cavity member 24. Surface contour details provided on the surface of the mold core member and on the surface of the mold cavity member serve to create the desired surface contours in the finished molded part, as is well known in the art. Typically, the mold cavity is positioned on a supporting base 26 and the mold core is pressed downward onto the mold cavity, as shown in FIG. 5C, to accomplish the compression molding effect. When the mold core and the mold cavity are pressed together, the particulate molding material previously placed in the mold cavity is compressed to form the final molded part 28 (see FIG. 5D). To cure the resin in the molding mixture and cause it to harden, the molded part is heated simultaneously with the application of pressure by applying heat through the mold core and mold cavity, which heating techniques are well known in the art.

Prior to the loading of the mold and the compression of the molded part, a ring member 30 having the shape of the periphery of the mold cavity 24, is first positioned to surround the peripheral rim of the mold cavity. This ring member is arranged to selectively move between a first position surrounding the peripheral rim of the mold cavity and a second position 30′ (FIG. 5D) clear of the rim of the mold cavity. In its first position, the ring member creates and defines a well area 33 (FIG. 5B) within the ring and above the surface of the mold cavity for receipt of the graphite/resin molding material 34.

Following compression and heating of the molded part, the ring member 30 is moved to its position 30′ clear of the mold cavity rim area and clear of the molded part (FIG. 5D). Such a move may be accomplished with a one-piece ring by shifting the ring either upward or downward, or the ring may be split and the sections separated to facilitate the move. In the preferred embodiment, the ring member is lowered. Means for moving this ring member may be manual, mechanical, hydraulic or air cylinder, or any other equivalent means know to the art. By so moving the ring member, the sides of the finished part are freed from the mold and the finished part is thereby exposed. This counteracts the tendency of the molded part to stick in the mold during the molding operation and lessens the force needed to eject the molded part. Consequently, the molded part is now easily ejected by well known ejection techniques.

As previously mentioned, apparatus for accurately and evenly loading the mold with the powdery particulate moldable material is depicted generally in FIG. 1 and in greater detail in FIG. 2. This apparatus includes a moveable table 12 having a target area 14 defined thereon. A through opening in the moveable table 12 defines the target area 14 and presents a plurality of spaced bars 32 positioned laterally across the opening.

For sifting, metering and layering the target area 14 with the particulate moldable material, such as the graphite/resin mixture previously described, there is provided material delivery means in the form of a movable hopper device 42 into which a measured amount of the moldable material is placed. This hopper device 42 is arranged to be driven in reciprocating fashion across the target area 14 and to thereby deposit an even layer of material onto the target area. Means for moving the hopper across the target area may include electrical means, hydraulic means, manual means, or other means known to the art. In the preferred embodiment this means for moving the hopper across the target area comprises a motor 44 affixed to the hopper support platform 46 and a gear mechanism 48 for moving the hopper back and forth across the target area on tracks 50.

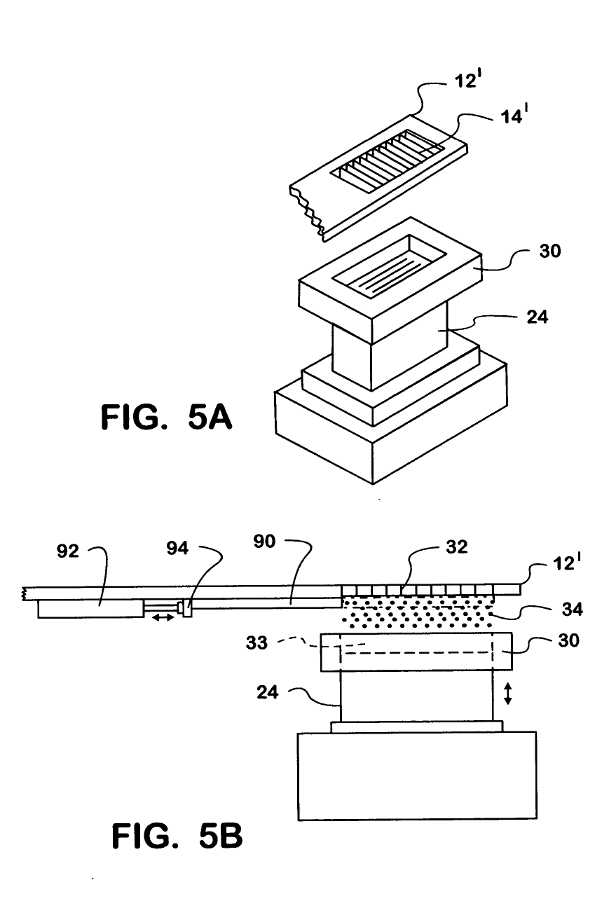

The hopper device, shown in detail in cross section in FIG. 4, includes a tapering enclosure positioned on the hopper support platform 46. This enclosure has two vertical sides 54 and two angled sides 56, such that the hopper enclosure narrows toward its lower extremity and defines an interior space. Within the interior space of the enclosure there is provided an upper screen 60 for sifting the particulate material measured into the hopper and a lower screen 62 at the outlet 64 of the hopper for sifting the material as it leaves the hopper at its lower extremity. Between the upper and lower screens there is provided a vibrating screen 66 for further metering and sifting of the particulate material. This vibrating screen 66 is arranged with a protrusion 68 for causing the screen to vibrate in response to repetitive contact, and in the preferred embodiment this protrusion comprises a dimple in the screen 66. To vibrate the vibrating screen 66, a rotating blade device consisting of a rotating member 70 having a plurality of blades 72 is positioned below the screen, such that the blades 72 are caused to contact the protrusion 68 during rotation of the rotating member 70.

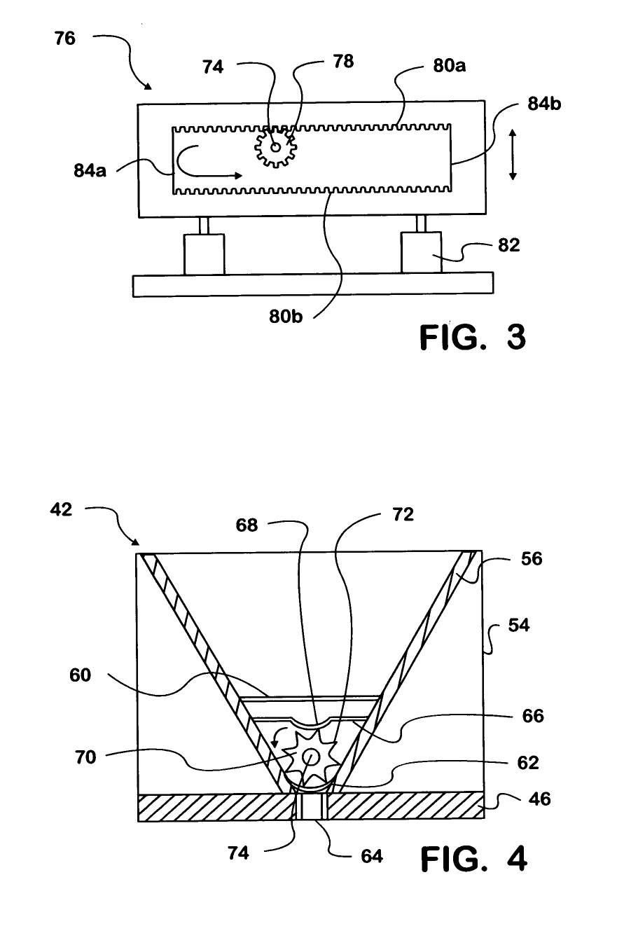

The rotating blade device is driven by means for driving said rotating blade device in response to the reciprocating motion of the hopper device. Particularly, a shaft 74 (see FIG. 2) is attached to the rotating member 70 and serves to cause the rotation thereof. This shaft is driven by a gear mechanism 76 (FIG. 3) that turns as the hopper support platform moves in reciprocal fashion across the target area 14. A constant direction of rotation is maintained by means for maintaining same and comprises, within the gear mechanism 76, a gear wheel 78 attached to the shaft 74 and caused to traverse lateral teeth 80a and 80b during the repetitive reciprocal movement of the hopper support platform. At the end of each stroke, in order to keep the gear wheel 78 and the shaft 74 from reversing direction, the gear mechanism 76 is synchronously raised and lowered by lifting means to position the alternate (lower 80b or upper 80a) lateral teeth against the gear wheel 78. This lifting means, in the preferred embodiment, comprises hydraulic or air cylinders 82 positioned under the gear mechanism 76 to lift and lower the gear mechanism when the gear wheel reaches the ends 84a and 84b of its traverse. Consequently, when the hopper starts its return stroke, the gear wheel will continue turning in the same direction, thereby avoiding a discontinuity in its turning motion and facilitating an even deposition of a layer of the material from the hopper.

Once the target area is layered with the particulate moldable material, the moveable table 12 is caused to shift 12′ toward the mold, positioning the loaded target area 14′ over the mold cavity. The movement of the table may be accomplished by means well known to the art, such as motors, hydraulics, air cylinders, manual operation, or other means well known to the art. In the preferred embodiment, this means for moving the moveable table 12 is accomplished with an air cylinder 86 attached by a connector 88 to the moveable table 12. When activated the air cylinder 86 causes the moveable table to slide on tracks 89 from its first position under the hopper to its second position (shown in phantom in FIG. 1) over the mold cavity. While this shift is shown and described as a lateral movement, it is to be understood that this move may be accomplished as a rotational move, a lateral move, or a combination of rotational and lateral moves, all of such movements being within the scope of the invention.

When the target area is in position over the mold cavity (FIG. 5A), the door 90 under the target area is selectively caused to open (FIG. 5B) to release the particulate moldable material 34 (graphite/resin mixture) into the well 33 of the mold cavity and create a layer of the material therein. During the movement of the door 90, the spaced bars 32 positioned across the opening of the target area come into play to keep the powdery mixture from shifting with the movement of the door 90. This movement of the door 90 may be accomplished by means for selectively opening the door 90, which means is well known to the art and includes motors, hydraulics, air cylinders, manual operation, or other equivalent means. In the preferred embodiment, this means for selectively moving the door 90 is accomplished using an air cylinder 92 affixed to the moveable table 12 and connected to the door 90 at the connecting block 94.

From the foregoing description, it will be apparent that modifications can be made to the apparatus and method for using same without departing from the teachings of the present invention. Accordingly, the scope of the invention is only to be limited as necessitated by the accompanying claims.

1. An apparatus for loading a mold cavity with particulate moldable material comprising:
a moveable table member;
a target area defined on said table member, said target area comprising an opening in said table member;
material delivery means for delivering a measured quantity of the particulate moldable material onto said target area;
a door positioned under said target area;
means for moving said moveable table member between a first position where said target area is loaded and a second position where said target area is positioned over the mold cavity; and
means for selectively opening said door to release the particulate moldable material into the mold cavity.

2. The apparatus of claim 1 wherein said material delivery means comprises a hopper device driven in reciprocating fashion across said target area.

3. The apparatus of claim 2 wherein said hopper device comprises a tapering enclosure having an opening at the bottom thereof and defining an interior space, and further comprising a screen positioned in said interior space for sifting the particulate moldable material loaded therein.

4. The apparatus of claim 3 wherein said hopper device further comprises a rotating blade device positioned within said enclosure and further comprises a screen positioned above said rotating blade device and arranged such that it is vibrated by said rotating blade device.

5. The apparatus of claim 4 further comprising means for driving said rotating blade device in response to said reciprocating motion of said hopper device and means for maintaining the direction of rotation of said rotating blade device during reversal in the direction of travel of said hopper device.

6. An apparatus for compression molding items from particulate moldable material comprising:
a compression mold having a mold core and a mold cavity, wherein said mold cavity has a selectively moveable ring positioned around the periphery thereof;
a moveable table member positioned proximate said compression mold;
a target area defined on said table member, said target area comprising an opening in said table member;
material delivery means for delivering a measured quantity of the particulate moldable material onto said target area;
a door positioned under said target area for selectively releasing the particulate moldable material into the mold cavity; and
means for moving said table member to place said target area over said mold cavity; and
means for selectively opening said door and thereby releasing said particulate moldable material into said mold cavity.

7. The apparatus of claim 6 wherein said material delivery means comprises a hopper device driven in reciprocating fashion across said target area.

8. The apparatus of claim 7 wherein said hopper device comprises a tapering enclosure having an opening at the bottom thereof and defining an interior space, and further comprising a screen positioned in said interior space for sifting the particulate moldable material loaded therein.

9. The apparatus of claim 8 wherein said hopper device further comprises a rotating blade device positioned within said enclosure and further comprises a screen positioned above said rotating blade device and arranged such that it is vibrated by said rotating blade device.

10. The apparatus of claim 9 further comprising means for driving said rotating blade device in response to said reciprocating motion of said hopper device and means for maintaining the direction of rotation of said rotating blade device during reversal in the direction of travel of said hopper device.

11. A method of loading a mold cavity of a compression mold with particulate moldable material comprising:
positioning a moveable table member proximate the compression mold,
wherein said table member has defined thereon:
a target area comprising an opening in said table member;
material delivery means for delivering a measured quantity of the particulate moldable material as a layer onto said target area; and
a door positioned under said target area for selectively releasing the particulate moldable material into the mold cavity;
loading said target area from said material delivery means; selectively moving said table member to place said loaded target area over the mold cavity; and
opening said door to release said particulate moldable material into the mold cavity to create a layer of particulate moldable material therein.

12. The method of claim 11 wherein said material delivery means comprises a hopper device driven in reciprocating fashion across said target area.

13. The method of claim 12 wherein said hopper device comprises a tapering enclosure having an opening at the bottom thereof and defining an interior space, and further comprising a screen positioned in said interior space for sifting the particulate moldable material loaded therein.

14. The method of claim 13 wherein said hopper device further comprises a rotating blade device positioned within said enclosure and further comprises a screen positioned above said rotating blade device and arranged such that it is vibrated by said rotating blade device.

15. The method of claim 14 further comprising driving said rotating blade device in response to said reciprocating motion of said hopper device and maintaining the direction of rotation of said rotating blade device during reversal in the direction of travel of said hopper device.

16. A method of compression molding a molded part with particulate moldable material comprising:
providing a mold cavity having a peripheral rim defined thereon, with a moveable ring member, wherein said ring member surrounds said rim of said mold cavity;
positioning a moveable table member proximate said mold cavity, wherein said table member has defined thereon:
a target area comprising an opening in said table member;
material delivery means for delivering a measured quantity of the particulate moldable material as a layer onto said target area; and
a door positioned under said target area for selectively releasing the particulate moldable material into said mold cavity;
layering the particulate moldable material onto said target area on said table member from said material delivery means;
selectively moving said table member to place said target area over said mold cavity;
opening said door to release the moldable material into said mold cavity to thereby create a layer of particulate moldable material therein;
forcing a mold core against said mold cavity and said moldable material placed therein, thereby compressing said moldable material, and heating said moldable material to form a molded part; and
moving said mold core and said ring member to expose the molded part.

17. The method of claim 16 wherein said material delivery means comprises a hopper device driven in reciprocating fashion across said target area.

18. The method of claim 17 wherein said hopper device comprises a tapering enclosure having an opening at the bottom thereof and defining an interior space, and further comprising a screen positioned in said interior space for sifting the particulate moldable material loaded therein.

19. The method of claim 18 wherein said hopper device further comprises a rotating blade device positioned within said enclosure and further comprises a screen positioned above said rotating blade device and arranged such that it is vibrated by said rotating blade device.

20. The method of claim 19 further comprising driving said rotating blade device in response to said reciprocating motion of said hopper device and maintaining the direction of rotation of said rotating blade device during reversal in the direction of travel of said hopper device.
